(19) United States
(12) Patent Application Publication
(10) Pub. No.: US 2020/0062018 A1
(43) Pub. Date: Feb. 27, 2020

(54) Customized Stationery Kit and Assembly

(71) Applicant: Jody Puckett, Port Washington, WI (US)

(72) Inventor: Jody Puckett, Port Washington, WI (US)

(21) Appl. No.: 16/422,893

(22) Filed: May 24, 2019

Related U.S. Application Data
(60) Provisional application No. 62/675,881, filed on May 24, 2018.

(51) Int. Cl. B42D 5/00

(52) U.S. Cl. CPC B42D 5/006; B41J 3/36

(57) ABSTRACT

The present invention is a method and system that provides the tools necessary to make your own customized notepads while eliminating crafting skills, moving parts, and cleanup supplies. It combines the electronic, computerized technologies of today with an age-old craft of personalized notepads. In addition, it provides another medium and use for digital “printables” that are exchanged on-line.

### REFERENCE TO RELATED APPLICATIONS

The present application claims priority to U.S. Provisional Patent Application Ser. No. 62/675,881 filed on May 24, 2018.

### BACKGROUND OF THE INVENTION

### Technical Field

The present embodiment of the invention relates to a new process and tools to create customized notepads. The components and method of kit eliminates the need for craft tools, cleaning supplies and crafting skills while utilizing today's electronic devices to create personalized notepads and calendars. Digital images and digitized content are part of our everyday life. This improved 4″×6″ pad system offers a new way to take that digital content and enjoy it in a convenient, portable, printed matter while consuming minimal labor output.

### BRIEF DESCRIPTION OF THE DRAWINGS

The invention can be better understood with reference to the following drawings and description. The components in the figures are not necessarily to scale, emphasis instead being placed upon illustrating the principles of the invention.

FIG. 1 is a perspective view of kit components and tools.

FIG. 2 is a perspective view of paper and chipboard backings.

FIG. 3a is an elevation view of clamps.

FIG. 3b illustrates clamps holding paper and chipboard backing for padding compound to be applied to taunt end.

FIG. 4 is an elevation view of padding compound bottle and brush cap applicator.

FIG. 5 shows a flow chart illustrating steps for creating a notepad according to an embodiment of the present invention.

### DETAILED DESCRIPTION

The elements illustrated in the Figures interoperate as explained in more detail below. Before setting forth the detailed explanation, however, it is noted that all of the discussion below, is exemplary in nature rather than limiting.

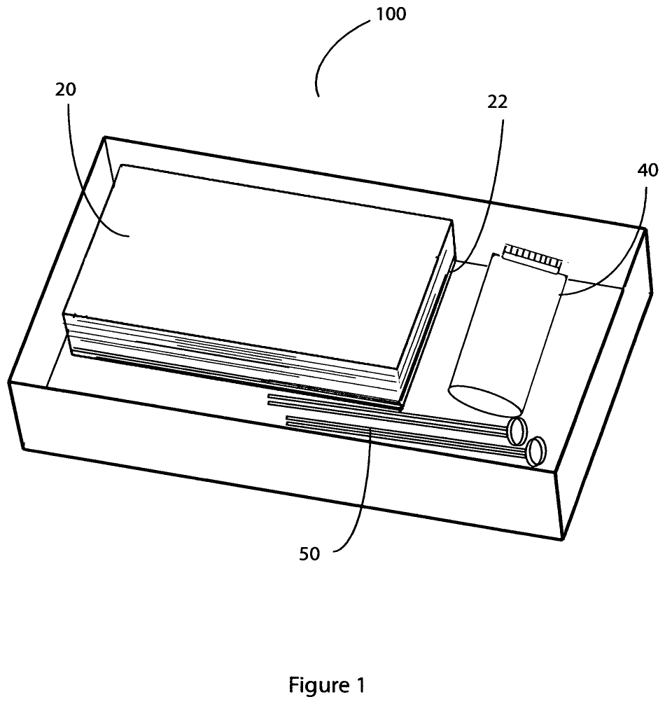

FIG. 1 is a perspective view of kit 100 components and tools according to an embodiment of paper 20, chipboard backings 22 the present tension clamps 50, and padding compound 40 with brush in cap self-applicator 41.

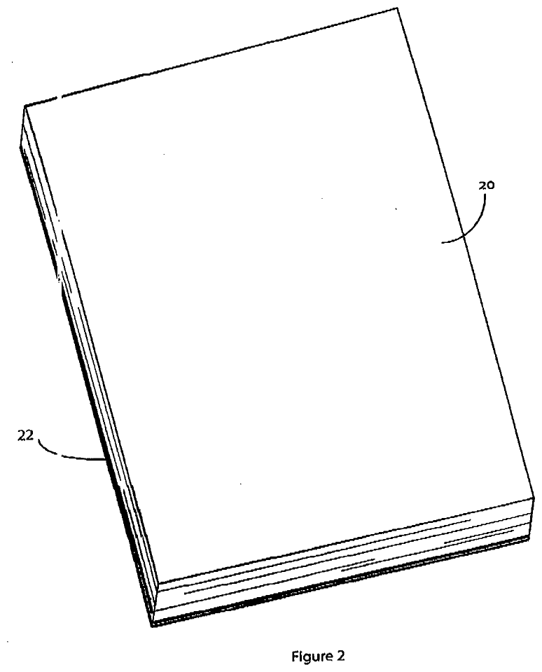

FIG. 2 is a perspective view of the 4″×6″ paper 20 and the 4″×6″ chipboard backings 22. The paper 20 is of 25-35 lb. text weight. In addition, the paper 20 is made of stock that is both laser and inkjet compatible. The finish allows for easy, clear writing with pen and pencil. The chipboard backings 22 can be of a plurality of rigid or semi rigid chipboard material.

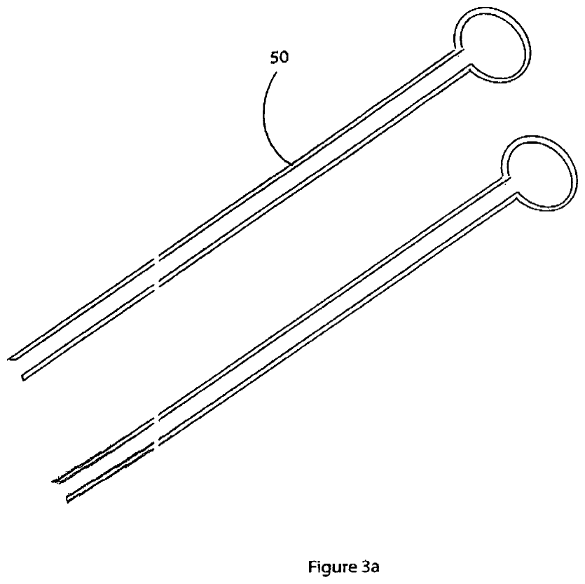

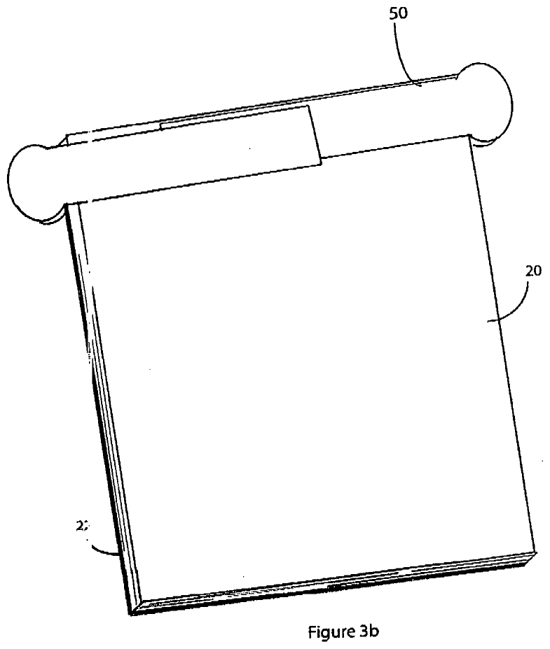

FIG. 3a is an elevation view of the slide on clamps 50.

FIG. 3b illustrates how the stamped metal clamps 50 provide tension to hold the bound edge tight to create a smooth edge in which padding compound 40 is applied. Each of the 2 clamps 50 slide on from each side edge, overlapping each other to create a snug fit. The clamps 50 may be slid in or out or up and down to vary the tension. The slide on clamps are a vast improvement from previous padding tension devices. The clamp can be slid into place easily with one hand, similar to applying a paperclip. In the past it was a two-hand operation to get paper into place, adjusting and tighter ring. It required removing your hand from the pad to insert paper into a clamp, thus increasing the chance for papers to move and not create the smooth binding surface. The crisp, smooth edges are one of the prominent features that give the notepads a professional, commercially printed appearance. In addition, the spherical end shape of clamps allow the pad to be elevated off the work surface for drying. Therefore, no pad or mat is required. The sleek design of the clamps is also an improvement for an overall aesthetically pleasing appearance which allow it to become a staple for any office desktop.

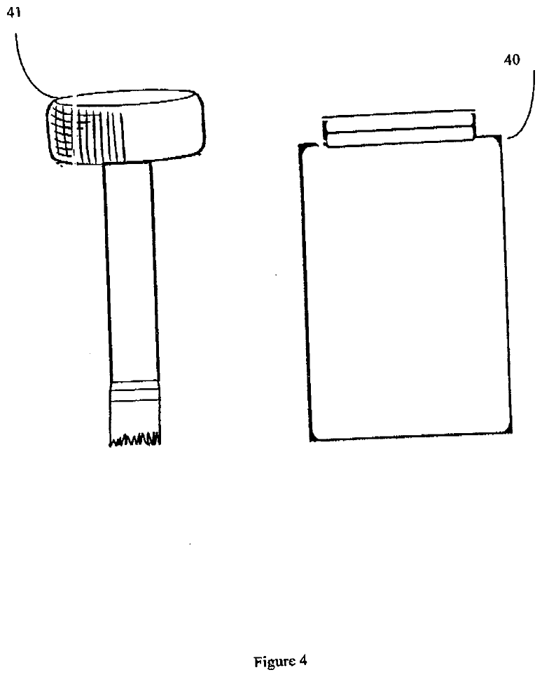

FIG. 4 is an elevation view of the padding compound bottle 40 and applicator lid 41. The lid is a screw-on-brush-in-cap applicator 41. This application tool eliminates the need for an additional tool, a paint brush. Therefore, it eliminates the biggest con of prior methods, the necessity to have access to water for brush cleanup. Thus, making it possible to sit at a desk and make pads without having to set up or have additional craft tools.

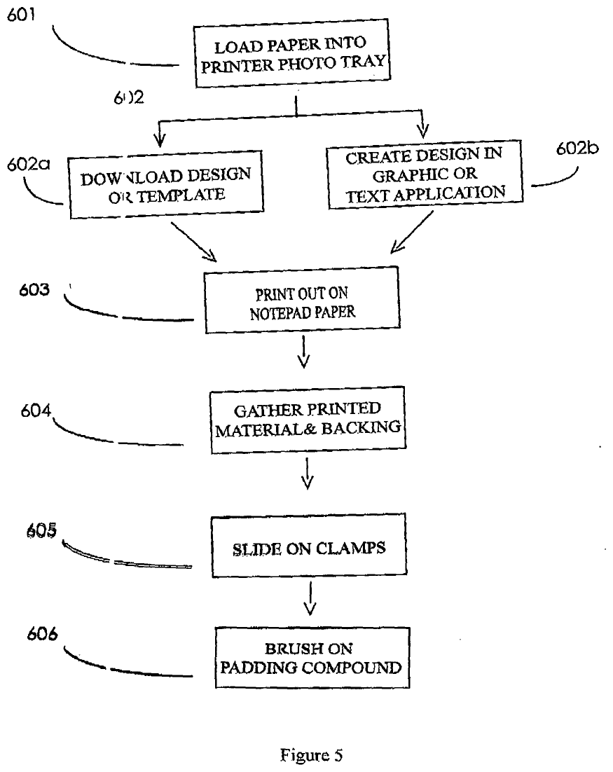

FIG. 5 is a process flow chart illustrating steps for creating personalized pads according to an embodiment of this present invention. Initially at step 601, a user inserts the 4″×6″ paper 20 into the “photo” tray of the printer. At step 602, the user then chooses their customized design by either downloading a pre-made digital design 602a or creating their own 602b through a Graphic/Text software or an on-line graphics program. At step 603 the user prints the customized work onto the paper 20. At step 604 the printed papers 20 and a chipboard backing 30 are gathered and straightened. At step 605 the clamps 50 are slid on from each side of the pad, running parallel to the desired bound edge. At step 606 the padding compound 40 is then applied to this edge by the brush in cap applicator 41.

An exemplary of digital designs that could be used, is through the use of smartphone apps. There are countless apps that are graphic design based; some pertaining to the smartphone photos that can be manipulated. These images and content can be sent effortless from mobile phone to printer in order to create notepads and calendars using these images.

### BRIEF SUMMARY OF INVENTION

We live in a technology-based world. This invention provides a new way to use some of those advances, such as photos taken on a smartphone to personalize a notepad or calendar while outputting minimal effort. This system utilizes today's advancements to requiring the least effort to create a personalized notepad or calendar within minutes. Many times, when creating a personalized craft there are certain craft skills required and a certain amount of cleanup is also required, this system eliminates both. A 4″×6″ paper can pass seamlessly through the printer to create, perfectly clean, edged notepads that are designed exactly as you want. No longer settling for a few design choices.

What is claimed is:

1. A system for creating 4″×6″ customized pads comprising of:
4″×6″ paper that prints image utilizing the “photo tray” of home printer with finish that accepts pencil and pen legibly.
4″×6″ chipboard backing
One-piece flat tension clamps
Padding Compound with brush-in-cap-screw-on applicator lid

2. The system of claim 1 wherein the 4″×6″ paper consist of 25-32 lb. basis weight.

3. The system of claim 1 wherein the padding compound is a self-applicator that requires no cleanup.

4. The system of claim 1 wherein the one-piece flat tension clamps slide on.

5. The system of claim 1 wherein said image is a digitized image.
